(19) United States
(12) Patent Application Publication
(10) Pub. No.: US 2003/0109343 A1
(43) Pub. Date: Jun. 12, 2003

(54) Drive belt stabilizer system

(76) Inventors: Lee Martinson, Tioga, ND (US); Steven Eide, Tioga, ND (US); Clifford Keever, Tioga, ND (US); Scott Lledle, Tioga, ND (US)

Correspondence Address: Michael S. Neustel, 2534 South University Drive, Suite No. 4, Fargo, ND, 58103, US

(21) Appl. No.: 10/015,343

(22) Filed: Dec. 11, 2001

(51) Int. Cl. F16H 7/22

(52) U.S. Cl. 474/136; 474/107; 474/138

(57) ABSTRACT

A drive belt stabilizer system for reducing non-longitudinal movement of a drive belt during operation. The drive belt stabilizer system includes a base, a lower member attached to the base, an upper member slidably positioned about the lower member in a vertical manner, a support stand attached to the upper member, a roller rotatably positioned within the support stand, a compression spring positioned within the lower member and the upper member for applying an expanding force relative thereto, and a securing shaft extending though the base and secured to the support stand for limiting the upward movement of the upper member. The roller is positioned beneath the return portion of a drive belt to be supported. A threaded nut is adjusted upon the securing shaft for adjusting the maximum height of the roller with respect to the drive belt.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to drive belt devices and more specifically it relates to a drive belt stabilizer system for reducing non-longitudinal movement of a drive belt during operation.

2. Description of the Prior Art

Drive belt systems have been in use for years. Typically, a motor includes a drive pulley that receives a portion of the drive belt which extends about a secondary pulley for driving machinery such as an oil well pumping unit. The drive belt may have various configurations such as but not limited to a flat structure. Because of the relatively long lengths of some drive belts (e.g. greater than six feet), oscillating movements within the return portion of the drive belt are common. The oscillating movements of the drive belt increase wear upon the machinery and the drive belt. The oscillating movements also contribute to decreased motor life. Over time, the drive belt becomes longer thereby providing more slack within the drive belt which contributes to increased non-longitudinal movements of the drive belt (often times referred to as “jumping”).

While these devices may be suitable for the particular purpose to which they address, they are not as suitable for reducing non-longitudinal movement of a drive belt during operation. Conventional drive belt systems do not provide a means that accommodates various fluctuations within a drive belt while simultaneously maintaining the return portion of the drive belt in a relatively taut manner to reduce non-longitudinal movements.

In these respects, the drive belt stabilizer system according to the present invention substantially departs from the conventional concepts and designs of the prior art, and in so doing provides an apparatus primarily developed for the purpose of reducing non-longitudinal movement of a drive belt during operation.

### SUMMARY OF THE INVENTION

In view of the foregoing disadvantages inherent in the known types of drive belt devices now present in the prior art, the present invention provides a new drive belt stabilizer system construction wherein the same can be utilized for reducing non-longitudinal movement of a drive belt during operation.

The general purpose of the present invention, which will be described subsequently in greater detail, is to provide a new drive belt stabilizer system that has many of the advantages of the drive belt devices mentioned heretofore and many novel features that result in a new drive belt stabilizer system which is not anticipated, rendered obvious, suggested, or even implied by any of the prior art drive belt systems, either alone or in any combination thereof.

To attain this, the present invention generally comprises a base, a lower member attached to the base, an upper member slidably positioned about the lower member in a vertical manner, a support stand attached to the upper member, a roller rotatably positioned within the support stand, a compression spring positioned within the lower member and the upper member for applying an expanding force relative thereto, and a securing shaft extending though the base and secured to the support stand for limiting the upward movement of the upper member. The roller is positioned beneath the return portion of a drive belt to be supported. A threaded nut is adjusted upon the securing shaft for adjusting the maximum height of the roller with respect to the drive belt.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a drive belt stabilizer system that will overcome the shortcomings of the prior art devices.

A second object is to provide a drive belt stabilizer system for reducing non-longitudinal movement of a drive belt during operation.

Another object is to provide a drive belt stabilizer system that may be utilized upon various types, sizes, lengths and structures of drive belt systems.

An additional object is to provide a drive belt stabilizer system that is capable of absorbing fluctuations within a drive belt based upon variations in the load and other external factors.

A further object is to provide a drive belt stabilizer system that is adjustable.

Another object is to provide a drive belt stabilizer system that is comprised of a simple construction.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention in an expanded position.

FIG. 2 is an upper perspective view of the present invention in a contracted position.

FIG. 3 is a cross sectional view taken along line 3-3 of FIG. 1.

FIG. 4 is a cross sectional view taken along line 4-4 of FIG. 2.

FIG. 5 is an exploded upper perspective view of the present invention.

FIG. 6 is an upper perspective view of the present invention positioned beneath a return portion of a drive belt in a contracted position.

FIG. 7 is an upper perspective view of the present invention positioned beneath a return portion of a drive belt in an extended position for maintaining the return portion taut.

FIG. 8 is an upper perspective view of the present invention positioned beneath a return portion of a drive belt within an oil well pumping unit.

### DESCRIPTION OF THE PREFERRED EMBODIMENT

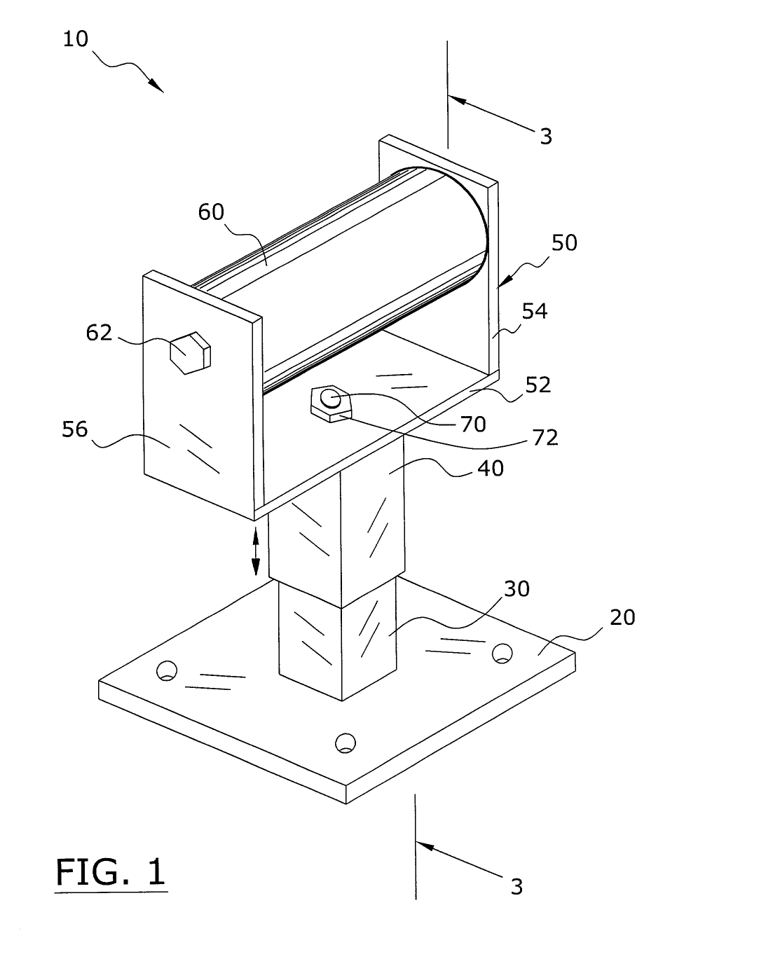

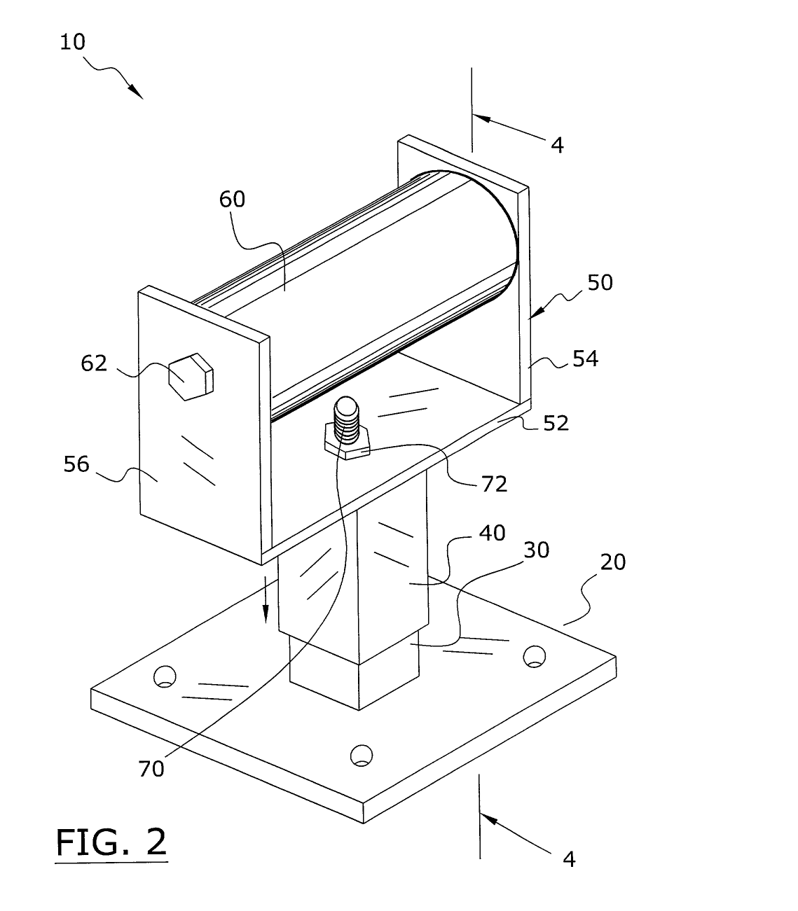

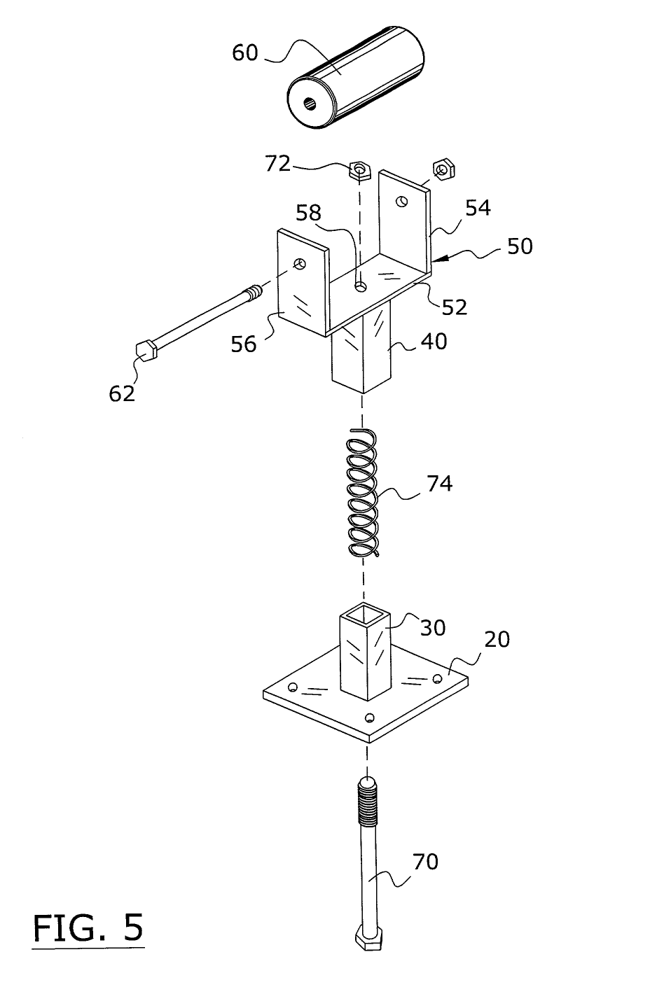

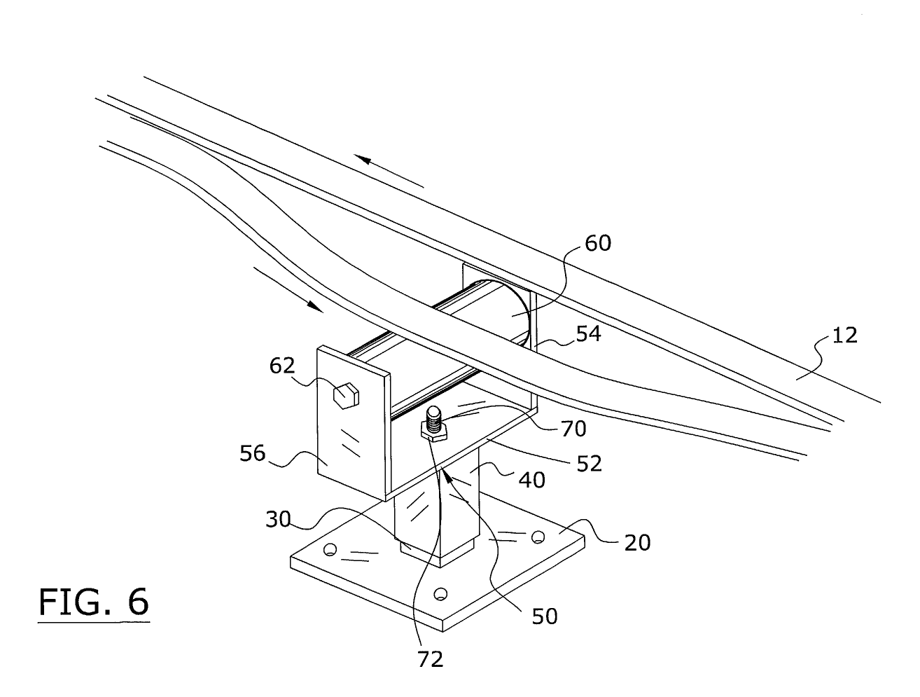

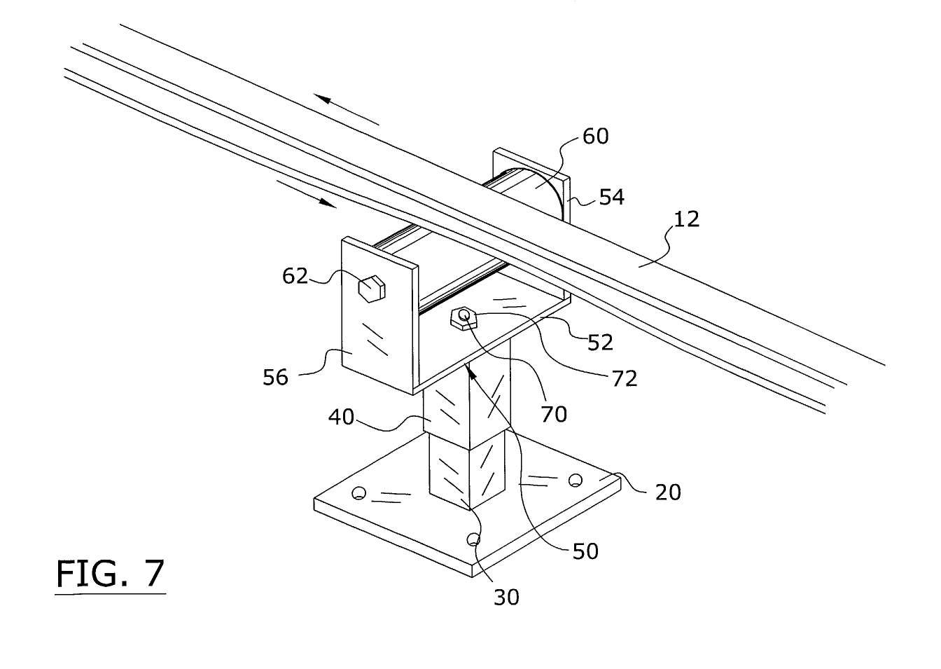

Turning now descriptively to the drawings, in which similar reference characters denote similar elements throughout the several views, FIGS. 1 through 8 illustrate a drive belt stabilizer system 10, which comprises a base 20, a lower member 30 attached to the base 20, an upper member 40 slidably positioned about the lower member 30 in a vertical manner, a support stand 50 attached to the upper member 40, a roller 60 rotatably positioned within the support stand 50, a compression spring 74 positioned within the lower member 30 and the upper member 40 for applying an expanding force relative thereto, and a securing shaft 70 extending though the base 20 and secured to the support stand 50 for limiting the upward movement of the upper member 40. The roller 60 is positioned beneath the return portion of a drive belt 12 to be supported. A threaded nut 72 is adjusted upon the securing shaft 70 for adjusting the maximum height of the roller 60 with respect to the drive belt 12.

As shown in FIGS. 1 through 8 of the drawings, the base 20 is a relatively broad structure for providing support to the structure. The base 20 may have various shapes, sizes and structures as can be appreciated. The base 20 may have a plurality of apertures within for receiving fasteners or similar securing devices to secure the base 20 to a stable structure to prevent movement thereof.

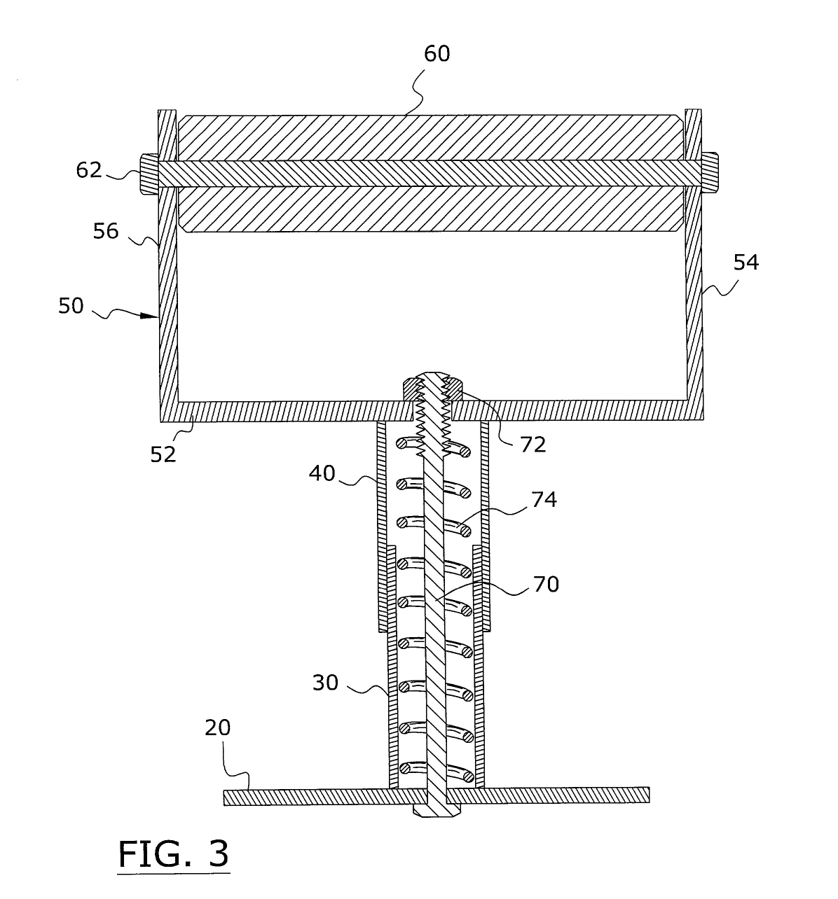

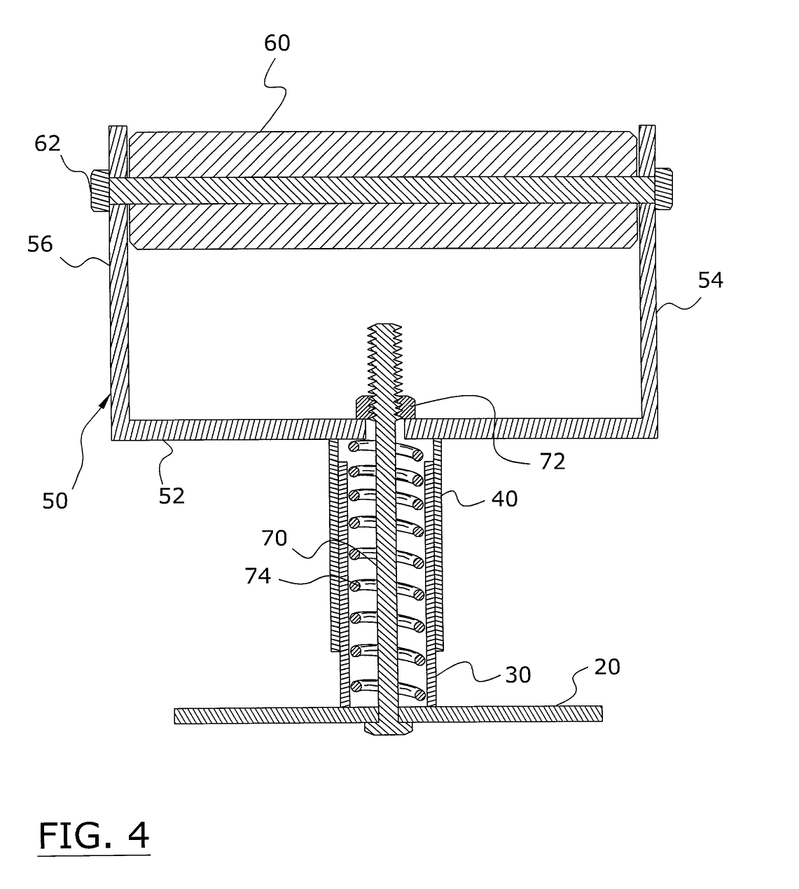

As shown in FIGS. 1 through 7 of the drawings, a lower member 30 is attached to an upper surface of the base 20. The lower member 30 is preferably comprised of an elongate tubular structure for receiving the compression spring 74 within as best illustrated in FIGS. 3 through 5 of the drawings. The lower member 30 extends traversely from the upper surface of the base 20 as best illustrated in FIGS. 3 and 4 of the drawings.

An upper member 40 is slidably positioned about the lower member 30 as best shown in FIGS. 1 through 7 of the drawings. It can be appreciated that the upper member 40 may be slidably positioned within the lower member 30 though not illustrated within the figures. The upper member 40 is comprised of an elongate tubular structure preferably having a cross section similar to the lower member 30. The upper member 40 is preferably formed to easily slide with respect to the lower member 30 while maintaining a relative parallel position with respect to the lower member 30 at all times.

As shown in FIGS. 1 through 7 of the drawings, a support stand 50 is attached to an upper end of the upper member 40. The support stand 50 is comprised of a U-shaped structure as best shown in FIGS. 3 and 4 of the drawings. The support stand 50 is comprised of a cross member 52 attached to the upper member 40, a first member 54 extending upwardly from one end of the cross member 52, and a second member 56 extending upwardly from an opposing end of the cross member 52 as shown in FIGS. 3 and 4 of the drawings. The first member 54 and the second member 56 are substantially parallel to one another as best illustrated in FIGS. 3 and 4 of the drawings.

The first member 54 and the second member 56 each include at least one aperture for receiving a fastener 62 that rotatably secures a roller 60 between thereof. The roller 60 may be comprised of various types of materials, sizes and diameters. The roller 60 may include bearings within for reducing frictional rotation thereof upon the fastener 62. The fastener 62 may be secured using a conventional nut or similar locking device. The roller 60 is preferably positioned within an upper portion of the support stand 50 for freely engaging the drive belt 12 and for reducing engagement with the securing shaft 70 during movement of the support stand 50. The roller 60 may also be rotatably positioned within the support stand 50 without the usage of a fastener 62 by utilizing opposing axles or related structures.

As shown in FIGS. 3 through 5 of the drawings, a compression spring 74 is positioned within the upper member 40 and the lower member 30 for applying an outward extending force to the upper member 40. The compression spring 74 may be comprised of various spring structures and forces. The upper end of the compression spring 74 engages the cross member 52 while the lower end of the compression spring 74 engages the upper surface of the base 20 as shown in FIGS. 3 and 4 of the drawings.

As best shown in FIGS. 3 through 5 of the drawings, a securing shaft 70 extends through the base 20 and the cross member 52. The securing shaft 70 is positioned within the compression spring 74, upper member 40 and the lower member 30 as shown in FIGS. 3 and 4 of the drawings. The securing shaft 70 has an upper threaded portion that threadably receives a threaded nut 72 for adjusting the maximum upward extension of the upper member 40 and support stand 50.

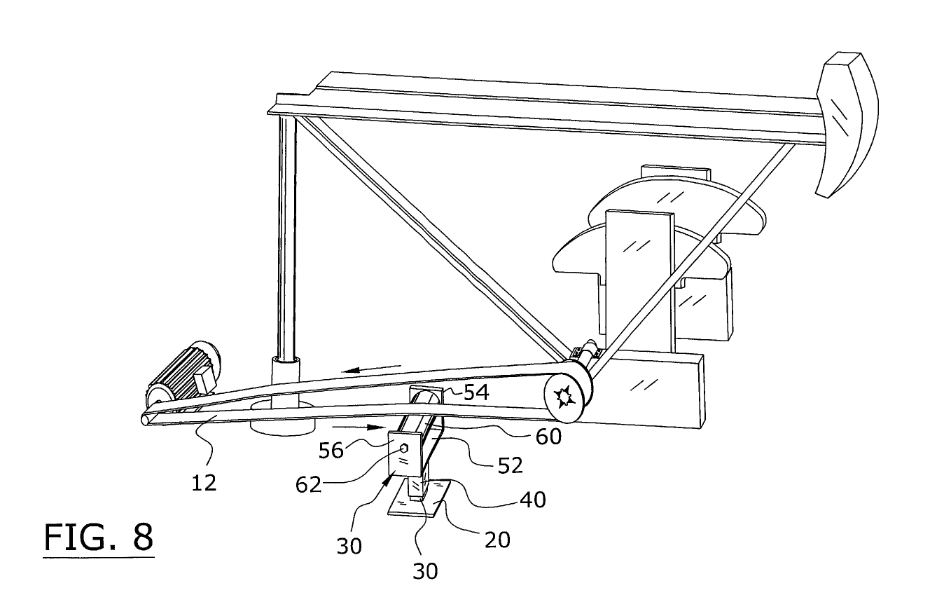

In use, the user secures the base 20 to a location positioned beneath the return portion of the drive belt 12 as shown in FIG. 8 of the drawings. The user then adjusts the maximum height of the roller 60 by rotating the threaded nut 72 upon the securing shaft 70 thereby limiting the upward movement of the upper member 40 and support stand 50 with respect to the lower member 30 and base 20. When the drive belt 12 is operated, the roller 60 rotates along with the movement of the drive belt 12 to reduce resistance upon the drive belt 12. When the return portion of the drive belt 12 encounters an increased force of tautness, the force of the drive belt 12 causes the drive belt 12 to straighten thereby applying a downward force upon the roller 60 and support stand 50. The downward force applied to the roller 60 causes the upper member 40 to slide downwardly upon the lower member 30 thereby compressing the compression spring 74. When the upper member 40 slides downwardly, the upper threaded portion of the securing shaft 70 is exposed further as the upper member 40 and the support stand 50 slide over the securing shaft 70 via an aperture 58 within the cross member 52. When the force is removed from the drive belt 12, the upper member 40 moves upwardly to the original position to maintain the drive belt 12 in a relatively taut state.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A drive belt stabilizer system for increasing the tautness of a return portion of a drive belt, comprising:
a base;
a lower member attached to said base;
an upper member slidably positioned upon said lower member;
a support stand attached to said upper member;
a roller rotatably positioned within said support stand, wherein said roller is formed for engaging said return portion of said drive belt; and
a spring positioned within said lower member and said upper member for applying a separating force between thereof.

2. The drive belt stabilizer system of claim 1, including a securing shaft extending through said base and said support stand for limiting an upper position of said upper member.

3. The drive belt stabilizer system of claim 2, including a threaded nut threadably attached to a threaded portion of said securing shaft.

4. The drive belt stabilizer system of claim 1, wherein said lower member and said upper member are comprised of corresponding cross sectional structures.

5. The drive belt stabilizer system of claim 1, wherein said lower member and said upper member are comprised of tubular structures.

6. The drive belt stabilizer system of claim 1, wherein said spring is comprised of a compression spring.

7. The drive belt stabilizer system of claim 6, wherein an upper end of said compression spring engages a lower surface of said support stand and wherein a lower end of said compression spring engages an upper surface of said base.

8. The drive belt stabilizer system of claim 1, wherein said roller is comprised of a nylon material.

9. The drive belt stabilizer system of claim 1, including an elongate fastener extending through said support stand and said roller for rotatably supporting said roller.

10. The drive belt stabilizer system of claim 1, wherein said roller has a length at least two times greater than a diameter of said roller.

11. A drive belt stabilizer system for increasing the tautness of a return portion of a drive belt, comprising:
a base;
a lower member attached to said base;
an upper member slidably positioned upon said lower member;
a support stand comprised of a cross member attached to said upper member, a first member extending traversely from a first end of said cross member and a second member extending traversely from a second end of said cross member;
a roller rotatably positioned within said support stand, wherein said roller is formed for engaging said return portion of said drive belt; and
a spring positioned within said lower member and said upper member for applying a separating force between thereof.

12. The drive belt stabilizer system of claim 11, including a securing shaft extending through said base and said support stand for limiting an upper position of said upper member.

13. The drive belt stabilizer system of claim 12, including a threaded nut threadably attached to a threaded portion of said securing shaft.

14. The drive belt stabilizer system of claim 11, wherein said lower member and said upper member are comprised of corresponding cross sectional structures.

15. The drive belt stabilizer system of claim 11, wherein said lower member and said upper member are comprised of tubular structures.

16. The drive belt stabilizer system of claim 11, wherein said spring is comprised of a compression spring.

17. The drive belt stabilizer system of claim 16, wherein an upper end of said compression spring engages a lower surface of said support stand and wherein a lower end of said compression spring engages an upper surface of said base.

18. The drive belt stabilizer system of claim 11, wherein said roller is comprised of a nylon material.

19. The drive belt stabilizer system of claim 11, including an elongate fastener extending through said support stand and said roller for rotatably supporting said roller.

20. The drive belt stabilizer system of claim 11, wherein said roller has a length at least two times greater than a diameter of said roller.
